(19) United States
(12) Patent Application Publication
(10) Pub. No.: US 2024/0023086 A1
(43) Pub. Date: Jan. 18, 2024

(54) RELIABILITY ENHANCEMENT FOR UPLINK TRANSMISSION

(71) Applicant: Apple Inc., Cupertino, CA (US)

(72) Inventors: Haitong Sun, Cupertino, CA (US); Dawei Zhang, Saratoga, CA (US); Wei Zeng, Saratoga, CA (US); Yushu Zhang, Beijing (CN); Hong He, San Jose, CA (US); Chunxuan Ye, San Diego, CA (US); Huaning Niu, San Jose, CA (US); Oghenekome Oteri, San Diego, CA (US); Seyed Ali Akbar Fakoorian, San Diego, CA (US); Sigen Ye, Whitehouse Station, NJ (US); Weidong Yang, San Diego, CA (US)

(73) Assignee: Apple Inc., Cupertino, CA (US)

(21) Appl. No.: 17/438,382

(22) PCT Filed: Aug. 5, 2021
(86) PCT No.: PCT/CN2021/111053

§ 371 Date: Feb. 9, 2023

(51) Int. Cl. H04W 72/1268; H04W 72/231; H04L 5/00; H04B 7/06

(52) U.S. Cl. CPC H04W 72/1268; H04W 72/231; H04L 5/0051; H04B 7/0639

(57) ABSTRACT

Provided is a method for a user equipment (UE), that includes: obtaining, from a network device, uplink transmission N configuration for uplink transmission to a plurality of transmission and reception points (TRP), the uplink transmission configuration being included in Radio Resource Control (RRC) message or Media Access Control (MAC) Control Element (MAC-CE) or Downlink Control Information (DCI); performing uplink transmission to the plurality of TRPs based on the uplink transmission configuration.

### TECHNICAL FIELD

This application relates generally to wireless communication systems, and more specifically to reliability enhancement for uplink transmission.

### BACKGROUND

Witless mobile communication technology uses various standards and protocols to transmit data between a base station and a wireless mobile device. Wireless communication system standards and protocols can include the 3rd Generation Partnership Project (3GPP) long term evolution (LTE); fifth-generation (5G) 3GPP new radio (NR) standard; the Institute of Electrical and Electronics Engineers (IEEE) 802.16 standard, which is commonly known to industry groups as worldwide interpretability for microwave access (WiMAX); and the IEEE 802.11 standard for wireless local area networks (WLAN), which is commonly known to industry groups as Wi-Fi. In 3GPP radio access networks (RANs) in LTE systems, the base station can include a RAN Node such as a Evolved Universal Terrestrial Radio Access Network (E-UTRAN) Node B (also commonly denoted as evolved Node B, enhanced Node B, eNodeB, or eNB) and/or Radio Network Controller (RNC) in an E-UTRAN, which communicate with a wireless communication device, known as user equipment (UE). In fifth generation (5G) wireless RANs, RAN Nodes can include a 5G Node, new radio (NR) node or g Node B (gNB), which communicate with a wireless communication device, also known as user equipment (UE).

### SUMMARY

According to an aspect of the present disclosure, a method for a user equipment (UE), comprising: obtaining, from a network device, uplink transmission configuration for uplink transmission to a plurality of transmission and reception points (TRP), the uplink transmission configuration being included in Radio Resource Control (RRC) message or Media Access Control (MAC) Control Element (MAC-CE) or Downlink Control Information (DCI); performing uplink transmission to the plurality of TRPs based on the uplink transmission configuration.

According to an aspect of the present disclosure, a method for a network device, comprising: generating uplink transmission configuration for uplink transmission for a user equipment (UE) to a plurality of transmission and reception points (TRP); transmitting, to the UE, Radio Resource Control (RRC) message or Media Access Control (MAC) Control Element (MAC-CE) or Downlink Control Information (DCI) including the uplink transmission configuration.

According to an aspect of the present disclosure, an apparatus for a user equipment (UE) is provided that comprises: one or more processors configured to perform steps of the above-mentioned method.

According to an aspect of the present disclosure, an apparatus for a network device that comprises: one or more processors configured to perform steps of the above-mentioned method.

According to an aspect of the present disclosure, it is provided a computer readable medium having computer programs stored thereon which, when executed by one or more processors, cause an apparatus to perform steps of the above-mentioned method.

According to an aspect of the present disclosure, it is provided an apparatus for a communication device, comprising means for performing steps of the above-mentioned method.

According to an aspect of the present disclosure, it is provided a computer program product comprising computer programs which, when executed by one or more processors, cause an apparatus to perform steps of the above-mentioned method.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure.

FIG. 1 is a block diagram of a system including a base station and a user equipment (UE) in accordance with some embodiments.

FIG. 2 illustrate an exemplary flowchart of a method for a UE in accordance with sotne embodiments of the present disclosure.

FIG. 3 illustrates a communication exchange in connection with PUCCH transmission in accordance with some embodiments of the present disclosure.

FIG. 4A illustrates an exemplary association of a PUCCH resource ID and a plurality of spatial relation information IDs.

FIG. 4B illustrates an exemplary association of a PUCCH resource ID and one spatial relation information ID.

FIG. 5 illustrate exemplary PUCCH repetition pattern in accordance with some embodiments of the present disclosure.

FIG. 6 illustrates a communication exchange in connection with PUSCH transmission in accordance with some embodiments of the present disclosure.

FIG. 7 illustrates exemplary different frequency hopping results in accordance with some embodiments.

FIG. 8 illustrates another exemplary different frequency hopping results in accordance with some embodiments.

FIG. 9 illustrate an exemplary flowchart of a method for a network device in accordance with some embodiments of the present disclosure.

FIG. 10 illustrates a communication device (e.g. a UE or a base station) in accordance with some embodiments.

FIG. 11 illustrates example interfaces of baseband circuitry in accordance with some embodiments.

FIG. 12 illustrates components in accordance with some embodiments.

FIG. 13 illustrates an architecture of a wireless network in accordance with some embodiments.

### DETAILED DESCRIPTION

In the present disclosure, a “base station” can include a RAN Node such as an Evolved Universal Terrestrial Radio Access Network (E-UTRAN) Node B (also commonly denoted as evolved Node B, enhanced Node B, eNodeB, or eNB) and/or Radio Network Controller (RNC), and/or a 5G Node, new radio (NR) node or g Node B (gNB), which communicate with a wireless communication device, also known as user equipment (UE). Although some examples may be described with reference to any of E-UTRAN Node B, an eNB, an RNC and/or a gNB, such devices may be replaced with any type of base station.

Carrier aggregation is a technology according to which multiple carrier signals operating on different frequencies may be used to carry communications for a single UE, thus increasing the bandwidth available to a single device. In some aspects, carrier aggregation may be used where one or more component carriers operate on unlicensed frequencies.

Multiple transmission and reception points (multi-TRPs or mTRPs) is vital for improving reliability of a wireless communication system. In order to support tremendous growth mobile data traffic and to enhance the coverage, the wireless devices are expected to access networks composed of multi-TRPs (i.e., macro-cells, small cells, Pico-cells, femto-cells, remote radio heads, relay nodes, etc.). The multi-TRPs may be deployed at different locations to provide diversity. In the description below, operations of a network may be implemented by any one of the multi-TRPs in the network. The number of the TRPs in the network may depend on actual situation. In some examples, the network may include. 2 TRPs.

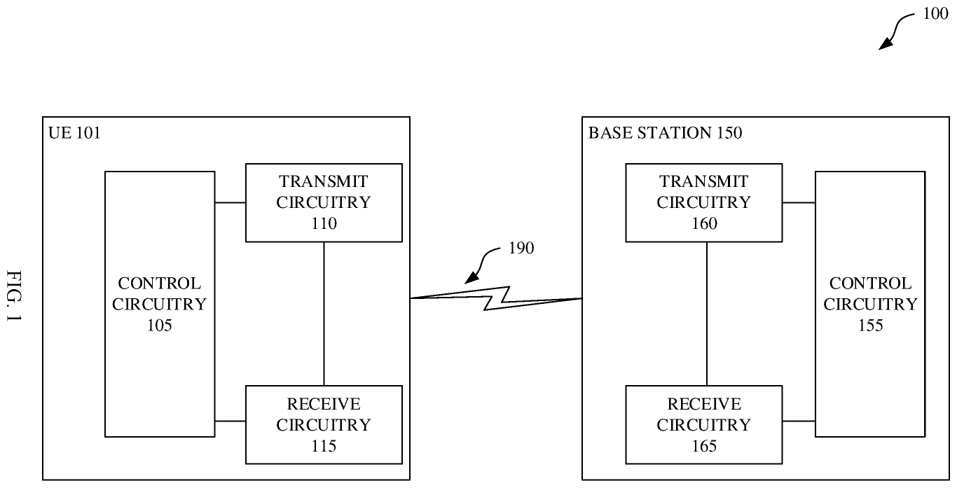

FIG. 1 illustrates a wireless network 100, in accordance with some embodiments. The wireless network 100 includes a UE 101 and a base station 150 connected via an air interface 190.

The UE 101 and any other UE in the system may be, for example, laptop computers, smartphones, tablet computers, printers, machine-type devices such as smart meters or specialized devices for healthcare monitoring, remote security surveillance, an intelligent transportation system, or any other wireless devices with or without a user interface. The base station 150 provides network connectivity to a broader network (not shown) to the UE 101 via the air interface 190 in a base station service area provided by the base station 150. In some embodiments, such a broader network may be a wide area network operated by a cellular network provider, or may be the Internet. Each base station service area associated with the base station 150 is supported by antennas integrated with the base station 150. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector. One embodiment of the base station 150, for example, includes three sectors each covering a 120-degree area with an array of antennas directed to each sector to provide 360-degree coverage around the base station 150.

The UE 101 includes control circuitry 105 coupled with transmit circuitry 110 and receive circuitry 115. The transmit circuitry 1 10 and receive circuitry 115 may each be coupled with one or more antennas. In some embodiments, the control circuitry 105 of the UE 101 may perform calculations or may initiate measurements associated with the air interface 190 to determine a channel quality of the available connection to the base station 150. These calculations may be performed in conjunction with control circuitry 155 of the base station 150. The transmit circuitry 110 and receive circuitry 115 may be adapted to transmit and receive data, respectively. The control circuitry 105 may be adapted or configured to perform various operations such as those described elsewhere in this disclosure related to a UE. The transmit circuitry 110 may transmit a plurality of multiplexed uplink physical channels. The plurality of uplink physical channels may be multiplexed according to time division multiplexing (TOM) or frequency division multiplexing (FDM). The transmit circuitry 110 may be configured to receive block data from the control circuitry 105 for transmission across the air interface 190. Similarly, the receive circuitry 115 may receive a plurality of multiplexed downlink physical channels from the air interface 190 and relay the physical channels to the control circuitry 105. The uplink and downlink physical channels may be multiplexed according to TDM or FDM. The transmit circuitry 110 and the receive circuitry 115 may transmit and receive both control data and content data (e.g. messages, images, video, et cetera) structured within data blocks that are carried by the physical channels.

FIG. 1 also illustrates the base station 150, in accordance with various embodiments. The base station 150 circuitry may include control circuitry 155 coupled with transmit circuitry 160 and receive circuitry 165. The transmit circuitry 160 and receive circuitry 165 may each be coupled with one or more antennas that may be used to enable communications via the air interface 190.

The transmit circuitry 160 and receive circuitry 165 may be adapted to transmit and receive data, respectively, within a narrow system bandwidth that is narrower than a standard bandwidth structured for person to person communication. In some embodiments, for example, a transmission bandwidth may be set at or near 1.4 MHz. In other embodiments, other bandwidths may be used. The control circuitry 155 may perform various operations such as those described elsewhere in this disclosure related to a base station.

Within the narrow system bandwidth, the transmit circuitry 160 may transmit a plurality of multiplexed downlink physical channels. The plurality of downlink physical channels may be multiplexed according to TDM or FDM. The transmit circuitry 160 may transmit the plurality of multiplexed downlink physical channels in a downlink super-frame that is comprised of a plurality of downlink subframes.

Within the narrow system bandwidth, the receive circuitry 165 may receive a plurality of multiplexed uplink physical channels. The plurality of uplink physical channels may be multiplexed according to TDM or FDM. The receive circuitry 165 may receive the plurality of multiplexed uplink physical channels in an uplink super-frame that is comprised of a plurality of uplink subframes.

As described further below, the control circuitry 105 and 155 may be involved with measurement of a channel quality for the air interface 190. The channel quality may, for example, be based on physical obstructions between the UE 101 and the base station 150, electromagnetic signal interference from other sources, reflections or indirect paths between the LIE 101 and the base station 150, or other such sources of signal noise. Based on the channel quality, a block of data may be scheduled to be retransmitted multiple times, such that the transmit circuitry 110 may transmit copies of the same data multiple times and the receive circuitry 115 may receive multiple copies of the same data multiple times.

The UE and various base stations (for example, base stations that support all kinds of serving cells including multiple TRPs, or base stations that act as the network device composed of multi-TRPs for communicating with the UE) described in the following embodiments may be implemented by the UE 101 and the base station 150 described in FIG. 1.

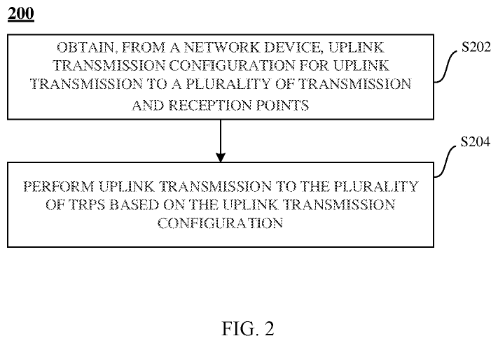

FIG. 2 illustrate an exemplary flowchart of a method for a UE in accordance with some embodiments of the present disclosure.

At step S202, the UE may obtain, from a network device, uplink transmission configuration for uplink transmission to a plurality of transmission and reception points (TRP), the uplink transmission configuration being included in Downlink Control Information (DCI), Media Access Control (MAC) Control Element (CE) (MAC-CE), or Radio Resource Control (RRC) message.

At step 204, the UE may perform uplink transmission to the plurality of TRPs based on the uplink transmission configuration.

Since the DCI received from the network includes uplink transmission configuration for uplink transmission to a plurality of TRPs, the uplink transmission to each TRP may be configured independently based on uplink transmission configuration for each TRP. Thus, the reliability of uplink transmission to a network including multi-TRPs may be enhanced.

In some embodiments, the uplink transmission may be Physical Uplink Control Channel (PUCCH) transmission.

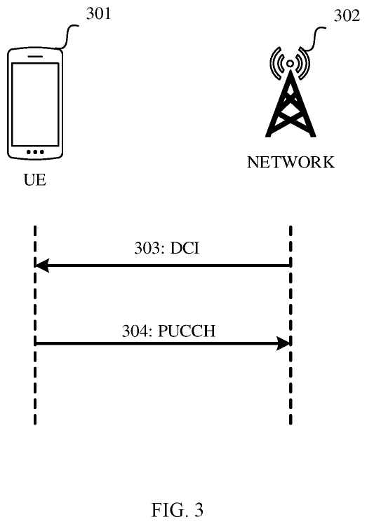

FIG. 3 illustrates a communication exchange in connection with PUCCH transmission in accordance with some embodiments of the present disclosure.

As shown in FIG. 3, a communication exchange between a UE 301 and a network 302 is shown.

At operation 303, the network 302 may transmit DCI, MAC-CE or RRC message to the UE 301. The DCI, MAC-CE or RRC message may include PUCCH configurations for the UE 301.

At operation 304, the UE 301 may perform PUCCH transmission according to the PUCCH configurations in the DCI, MAC-CE or RRC message received at operation 301. For example, the UE 301 may transmit Uplink Control Information (UCI) such as Channel State Information (CST), SR (Scheduling Request), and Hybrid Automatic Repeat Request (HARQ) feedback by PUCCH.

For purpose of power control, the uplink transmission configuration may include a closed loop power control (CLPC) parameter for the plurality of TRPs.

In terms of power control, the network may transmit a power control command to the UE to increase or decrease transmission powers for PUCCH resources.

In some implementations, the CLPC parameter may include a plurality of closed loop indices for different TRPs. Each closed loop index may be used for one TRP of the plurality of TRPs. Taking the network with 2 TRPs as an example, a first closed loop index may be used for a first TRP, and a second closed loop index may be used for a second TRP. When a Transmission Power Control (TPC) command is transmitted to the UE from the network, the UE may update transmitting powers for PUCCH resources configured with the same closed loop index according to the TPC command.

In some examples, the CLPC parameter may include different closed loop indices for different TRPs. For example, the first closed loop index and the second closed loop index may be different from each other. Configuration of different closed loop indices for different TRPs may Reduce interference among different TRPs.

In other examples, the CLPC parameter may include a same closed loop index for different TRPs. For example, the first closed loop index and the second closed loop index may be the same. Configuration of same closed loop index for different TRPs may reduce overhead of control for multi-TRPs.

In Frequency Range (FR) 1, the closed loop indices for PUCCH resource for each of the plurality of TRPs may be explicitly configured in a Radio Resource Control (RRC) configuration or a Media Access Control (MAC)-Control Element (CE) (MAC-CE) configuration. In some examples, RRC/MAC-CE configures different closed loop indices (closedLoopIndex) for different TRPs. In other examples, RRC/MAC-CE configures the same closed loop index (closedLoopIndex) for different TRPs. For example, closedLoopIndex may be configured to one of values of 0 and 1.

In FR2, the closed loop index for PUCCH resource for each of the plurality of TRPs may be configured in spatial relation information for PUCCH (PUCCH-SpatialRelationInfo) for respective TRPs. The spatial relation information may be included in an RRC configuration message. Each PUCCH resource may be configured with the spatial relation information. For multi-TRP PUCCH, the PUCCH resource may be configured with different spatial relation information for different TRPs. In some examples, a first PUCCH-SpatialRelationInfo for the first TRP may be configured with a first closed loop index (elosedLoopIndex), and a second PUCCH-SpatialRelationInfo for the second TRP may be configured with a second closed loop index. The first closed loop index configured in the first PUCCH-SpatialRelationInfo, and the second closed loop index configured in the second PUCCH-SpatialRelationInfo may be the same or different from each other.

In some other implementations, the CLPC parameter may include Transmission Power Control (TPC) parameters for the plurality of TRPs.

The TPC parameter may be defined in a TPC field configured in DC1 format 1_1/1_2, and the UE may receive the TPC parameter in a TPC command from the network. For example, the value of the TPC parameter may indicate an absolute transmission power or a change to a current transmission power for the PUCCH resource transmitted to the plurality of TRPs.

In some implementations, the TPC parameter may include a first TPC parameter for the first TRP, and a second TPC parameter for the second TRP. The first TPC parameter and the second TPC parameter may be the same or different from each other.

In some examples, the DCI received by the UE from the network may include a single TPC field, and the TPC parameters, including both of the first TPC parameter and the second TPC parameter, may be defined in the single TPC field.

For example, the single TPC field may be configured in case that a same closed loop index (closedLoopIndex) is configured for the plurality of TRPs. In this example, since the closed loop indices are the same among the plurality of TRPs, the single TPC field may be defined with a single TPC value, the all of the plurality of TRPs with the same closedLoopIndex may use a same CLPC.

For another example, the single TPC field may also be configured in case that different closed loop indices are configured for the plurality of TRPs. Thus, power control may be provided for each TRP based on its own location and channel condition.

In an example, the bits included in the single TPC field may be segmented to a plurality of portions, and each portion may be used for one TRP. Taking a first TRP configured with a first closedLoopIndex and a second TRP configured with a second closedLoopIndex as an example, a first set of hits in the TPC field may be configured for a first TPC parameter for a first TRP of the plurality of TRPs, and a second set of bits in the TPC field may be configured for a second TPC parameter for a second TRP of the plurality of TRPs. For a 2-bit TPC field, a first 1 bit of the TPC field may be used for the first TRP, and a second 1 bit of the TPC field may be used for the second TRP. In this way, the usage single TPC field may be extended for multi-TRPs to control CLPC of each TRP independently without increasing overhead of the DC1.

In another example, a legacy bit width of the TPC field may be increased in ogler to define the different closed loop indices for the multi-TRPs. For example, the legacy bit width of 2-bit of the TPC field may be increased to 4 bit. The first 2 bits of an increased TPC field may be used for the first TRP, and the second 2 bit of the increased TPC field may be used for the second TRP. In this way, the usage single TPC field may be extended for multi-TRPs to control CLPC of each TRP independently without scarifying step size of the TPC command.

UE may perform dynamic switch between a single TRP (sTRP) operation and a multi-TRP (mTRP) operation based on a dynamic switch command received from the network. For sTRP operation, a selected TRP among the plurality of TRPs may be scheduled for PUCCH transmission. For mTRP operation, the plurality of TRPs may be scheduled for PUCCH transmission.

In case that the dynamic switch command indicates a scheduled TRP and schedules the sTRP operation through the scheduled TRP of the plurality of TRPs, the TPC parameter received by the UE in the TPC command may be used for updating CLPC for the scheduled TRP. In case that the dynamic switch command schedules the mTRP operation through the plurality of TRPs, the TPC parameter received by the UE in the TPC command may be used for updating CLPC for all of the plurality of TRP.

In some examples, the DCI received by the UE from the network may include a plurality of TPC fields. Each of the TPC fields may be configured for a corresponding closed loop index configured for the plurality of TRPs.

A number of the TPC field may be the same as a number of the closed loop indices configured for the PUCCH resource. If different closed loop indices am configured for different TRPs, the DCI may include a plurality of TPC fields.

For example, in case that a same closed loop index is configured for PUCCH resources for all of the plurality of TRPs, the number of the TPC field may be t as well. For another example, in case that two different closed loop indices are configured for PUCCH resources for a first TRP and a second TRP, respectively, the number of TPC fields may be 2.

The number of TPC fields may also be the same as the number of TRPs. Since each of the plurality of TRPs may be configured with a different closed loop index, the number of TPC fields may be extended to be the same as the maximum number of closed loop index that can be configured for the PUCCH. It can be understood that the maximum number of closed loop index may be the same as the number of TRPs.

In case that a plurality TPC fields is configured in the DCI, the following solutions may be adopted by the UE for applying the TPC fields.

In case that a same closed loop index is configured for different TRPs, the UE may apply one TPC filed of the plurality of TPC fields to CLPC with the same closed loop index. Taking the TPC fields including a first TPC field and a second TPC field as an example, the UE may apply only the first TPC field or only the second TPC field to the CLPC with the same closed loop index. Alternatively, the UE may apply all of the plurality of TPC fields to CLPC with the same closed loop index. The bit widths of the first TPC field and the second TPC field may be used as a combination field in order to reduce the step size of the TPC command. For example, if two TPC fields are configured in the DO, an each TPC field has a bit width of 2 bits, the 4 bits of the two TPC fields may be used as a combination to be applied to CLPC with the same closed loop index.

In case that different closed loop indices are configured for different TRPs, each TPC field configured in the DCI may be applied to CLPC with a corresponding closed loop index. Taking a first TPC field and a second TPC field as an example, the UE may apply a first TPC field to CLPC corresponding to a first closed loop index, and a second TPC field of the plurality of TPC fields to CLPC corresponding to a second closed loop index. The first closed loop index may be different from the second closed loop index.

In some embodiments, the DCI may further include a toggling indication indicating a toggling between a sTRP operation and a mTRP operation. The UE may determine to apply one TPC field of the plurality of TPC fields or all of the plurality of TPC fields configured in the DCI based on the toggling indication. For example, in case that the toggling indication indicates the sTRP operation, the UE may apply one TPC field of the plurality of TPC fields to CLPC for the scheduled TRP in the sTRP operation. Taking two TPC fields configured in the DCI as an example, the UE may apply only a first TPC field of the two TPC fields, or apply only a second TPC field of the two TPC fields, or apply both of the TPC fields for the sTRP operation. For example, both of the TPC fields may be applied to CLPC with the same closed loop index or CLPCs with two different closed loop indices. When using both of the two fields for the CLPC with the same closed loop index, the step size of the TPC command may be decreased and the bit width set for the TPC fields will not be wasted.

For purpose of PUCCH spatial relation configuration, the uplink transmission configuration may include at least one set of spatial relation information for the plurality of TRPs. Each PUCCH resource for PUCCH transmission to at least one TRP of the plurality of TRPs may be associated with the at least one set of spatial relation information.

In some implementations, the DCI may include associations indicating that each PUCCH resource is associated with a plurality of sets of spatial relation information, each set of spatial relation information is used for one TRP of the plurality of the TRPs, in some examples, the association may indicate that a particular PUCCH resource ID is associated with a plurality of spatial relation information IDs corresponding to the plurality of TRPs respectively. Each of the plurality of spatial relation information IDs represent a single set of spatial relation parameters configured for one TRP of the plurality of TRPs.

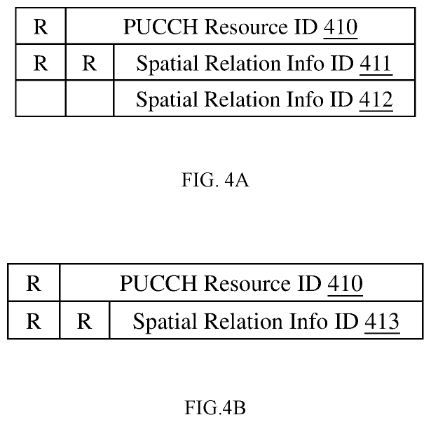

FIG. 4A illustrates an exemplary association of a PUCCH resource ID and a plurality of spatial relation information IDs.

As shown in FIG. 4A, a PUCCH resource ID 410 may be associated with spatial relation information ID 411 and spatial relation information ID 412. The association with the PUCCH resource ID with the spatial relation information ID may apply spatial relation information represented by the spatial relation information ID 411 and the spatial relation information ID 412 to the PUCCH resource represented by the PUCCH resource ID 410.

The association of the PUCCH resource ID and the spatial relation information ID may be configured by MAC-CE.

For each PUCCH resource. MAC-CE may configure either one or two PUCCH spatial relation. That is, for sTRP operation, MAC-CE may associate corresponding one PUCCH spatial relation information ID for the scheduled TRP to the PUCCH resource, while for mTRP operation, MAC-CE may associate at least two PUCCH spatial relation information IDs for the TRPs to the PUCCH resource.

In FR1, the spatial relation information may include power control parameters without beam management parameters. The power control parameter may include Open Loop Power Control (OLPC) settings including Pathloss Reference Signals (PLRS) and P0 (desired received power at network side), and closed loop index for CLPC.

In FR2, the spatial relation information may include beam management parameters and power control parameters. The beam management parameters may indicate a beam used for PUCCH, and the power control parameters may include Open Loop Power Control (OLPC) settings including Pathloss Reference Signals (PLRS) and P0 (desired received power at network side), and closed loop index for CLPC. A parameter of PUCCH-SpatialRelationbrfo received in RRC configuration from the network may be considered as the spatial relation information discussed herein in FR2.

For spatial relation configuration in FR1, the parameter of PUCCH-SpatialRelationInfo may be used to configure the spatial relation in FR1 by removing the parameters for beam management, or making the parameters for beam management optional, or ignoring the parameters for beam management, since beam needs not to be configured in FR1.

In some other implementations, the DCI may include associations indicating that each PUCCH resource is associated with one set of spatial relation information, and the set of spatial relation information includes a plurality of subsets of spatial relation parameters, each subset of spatial relation parameters is used for one TRP of the plurality of the TRPs. In some examples, the association may indicate that a particular PUCCH resource ID is associated with one spatial relation information ID representing a plurality of sets of spatial relation parameters. The plurality of sets of spatial relation parameters are configured for the plurality of TRPs respectively.

FIG. 4B illustrates an exemplary association of a PUCCH resource ID and one spatial relation information ID.

As shown in FIG. 4B, a PUCCH resource ID 410 may be associated with one spatial relation information ID 413. The association with the PUCCH resource ID with the spatial relation information ID may apply spatial relation information represented by the spatial relation information ID 413 to the PUCCH resource represented by the PUCCH resource ID 410.

In order to provide respective spatial relation configurations for multi-TRPs, the spatial relation information represented by spatial relation information ID 413 may include a plurality of subsets of spatial relation parameters. Each subset of spatial relation parameters may be used for one TRP of the plurality of the TRPs.

In FR2, a first subset of spatial relation parameters may include a first beam used for PUCCH (including a servingCellId and a referenceSignal configured for the first TRP), a first OLPC settings (including a pucch-PathlossReferenceRS-Id and a p0-PUCCH-Id configured for the first TRP), and a first closed loop index (including a closedLoopIndex configured for the first TRP), and a second subset of additional spatial relation parameters may include a second beam used for PUCCH (including additional servingCellId and additional referenceSignal configured for the second TRP), a second OLPC settings (including additional pucch-PathlossReferenceRS-Id and additional p0-PUCCH-Id configured for the second TRP), and a second closed loop index (including additional closedLoopIndex configured for the second TRP). A parameter of PUCCH-SpatialRelationInfo received in RRC configuration from the network may be modified to contain the additional spatial relation parameters and considered as the spatial relation information discussed herein in FR2.

For spatial relation configuration in FR1, the parameter of PUCCH-SpatialRelationInfo may be used to configure the spatial relation in FR1 by removing the parameters for beam management (including the servingCellId and the referenceSignal), or making the parameters for beam management optional, or ignoring the parameters for beam management, since beam need not to be configured in FR1. Otherwise, a new configuration for spatial relation configuration in FR1 may be introduced, and RRC and MAC-CE may be introduced to configure OLPC settings including PLRS and P0 and closed loop index for CLPC per TRP for a particular PUCCH resource for the plurality of TRPs.

For purpose of power control, the uplink transmission configuration may include repetition configuration.

In some implementations, the repetition configuration may indicate that a PUCCH repetition is taken away from a configured number of PUCCH repetitions when the PUCCH repetition is invalid.

In some other implementations, the repetition configuration may indicate that a PUCCH repetition is skipped when the PUCCH repetition is invalid and continue the PUCCH repetition until configured number of PUCCH repetitions are done.

The configured number of PUCCH repetition may be scheduled based on schedule information from the network.

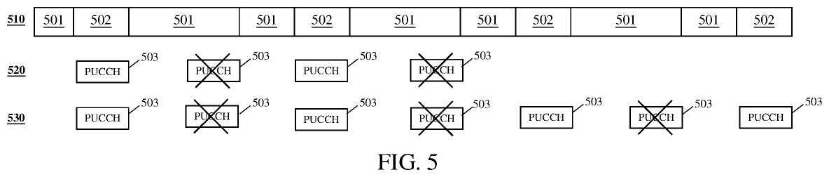

FIG. 5 illustrate exemplary PUCCH repetition pattern in accordance with some embodiments of the present disclosure.

As shown in FIG. 5, the UE may perform transmission according to a scheduled process 510 according to scheduling information received from the network. In process 510, blocks 501 are symbols for downlink (DL) transmission, and blocks 502 are symbols for uplink (UL) transmission.

Process 520 shows a first PUCCH repetition process in accordance with embodiments of the present disclosure. As shown in process 520, taking the configured number of PUCCH repetitions being 4 as an example, the PUCCH resources 503 are repeated 4 times. However, when the PUCCH resource is invalid due to collision with the scheduled symbols 501 for DL, transmission, the invalid PUCCH resource will be taken away from the configured number of PUCCH repetitions. Thus, actual numbers of repetition may be less that the configured number of PUCCH repetitions.

Process 530 shows a second PUCCH repetition process in accordance with embodiments of the present disclosure. As shown in process 520, taking the configured number of PUCCH repetitions being 4 as an example, the PUCCH repetition is skipped when the PUCCH repetition is invalid due to collision with the scheduled symbols 501 for DL transmission, and LIE continues to repeat transmitting the PUCCH resource 503 until the configured number of PUCCH repetitions of 4 are completed.

In other embodiment, the uplink transmission may be Physical Uplink Shared Channel (PUSCH) transmission.

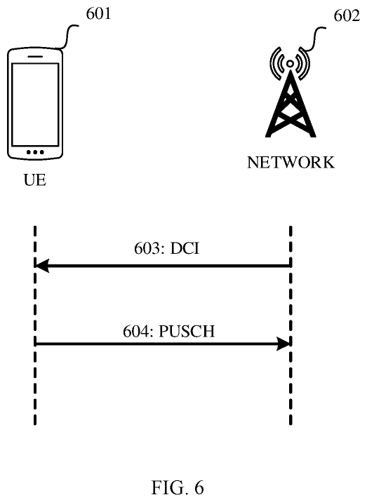

FIG. 6 illustrates a communication exchange in connection with PUSCH transmission in accordance with some embodiments of the present disclosure.

As shown in FIG. 6, a communication exchange between a UE 601 and a network 602 is shown.

At operation 603, the network 602 may transmit DCI to the UE 601. The DCI may include PUSCH configurations for the UE 601.

At operation 604, the UE 601 may perform PUSCH transmission according to the PUSCH configurations in the DCI received at operation 601. For example, the UE 601 may data or some uplink control information by PUSCH.

In the case of Physical Uplink Shared Chanel (PUSCH) transmission, for PUSCH repetition type A, the current frequency hopping process includes supporting two types of frequency hopping. One is the frequency hopping within the time slot, and the other is the frequency hopping between time slots in the case of time slot aggregation. Specifically. Intra-slot frequency hopping is applicable to single-slot and multi-slot PUSCH transmission. Another type of Inter-slot frequency hopping is applicable to multi-slot PUSCH transmission. These two different frequency hopping methods are based on the assumption of Resource Block (RB) offset parameter RB_{offset}. The specific details are as follows,

For inter-slot frequency hopping, the starting RB during slot nₛ^{μ} is given by:

$${RB}_{start} ( {n}_{s}^{μ} ) = \{ \begin{matrix}{RB}_{start} & {n}_{s}^{μ} mod 2 = 0 \\ ( {RB}_{start} + {RB}_{offset} ) mod {N}_{BWP}^{size} & {n}_{s}^{μ} mod 2 = 1\end{matrix} \qquad ( 1 )$$

where nₛ^{μ} is the current slot number within a radio frame, RBₛₜₐᵣₜ is the starting RB, and modN_{BWP}^{size} indicates a sire of a bandwidth part.

For the other condition PUSCH repetition type B, a UE is configured for frequency hopping by the higher layer parameter frequencyHoppingDCI-0-2 in PUSCH-Config for PUSCH transmission scheduled by DCI format 0_2. In the case of inter-repetition frequency hopping, the starting RB for an actual repetition within the n-th nominal repetitions given by:

$${RB}_{start} ( n ) = \{ \begin{matrix}{RB}_{start} & n mod 2 = 0 \\ ( {RB}_{start} + {RB}_{offset} ) mod {N}_{BWP}^{size} & n mod 2 = 1\end{matrix} \qquad ( 2 )$$

where n is the current slot number within a radio frame, RBₛₜₐᵣₜ is the starting RB, and modN_{BWP}^{size} indicates a sire of a bandwidth part.

Based on existing specifications and agreements, for the single DCI based mTRP PUSCH repetition Type A and B, the possibility to configure either cyclic mapping or sequential mapping of UL beams is allowed. A method for application of frequency hopping for PUSCH transmission in mTRP operation is introduced herein.

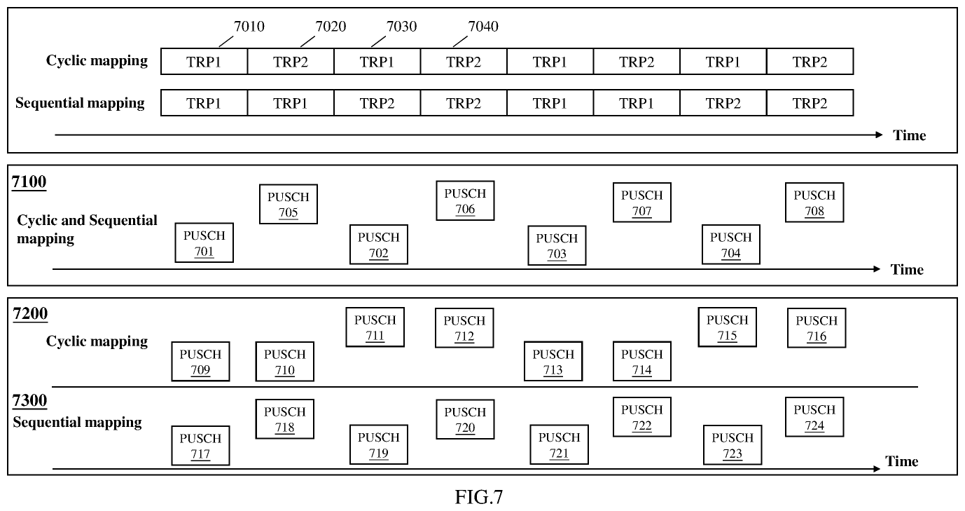

FIG. 7 illustrates exemplary different frequency hopping results in accordance with some embodiments.

In cyclic mapping for 2 TRPs, the odd number of slots within a radio frame are used for TRP1 and the even number of slots are used for TRP2. Unlike this, in sequential mapping, each TRP has two consecutive repetitions. The transmission sequence for TRP1 and TRP2 may be scheduled by the network.

Process 7100 shown in FIG. 7 shows an exemplary process of frequency hopping for PUSCH repetition type A. In process 7100, frequency hopping for PUSCH repetition type A for the plurality of TRPs may rely on a slot number within a radio frame.

Process 7100 is arrived at based on the existing frequency hopping calculation method for inter-slot frequency hopping for PUSCH repetition type A (e.g., equation (1) mentioned above). As shown in process 7100, the PUSCH transmission hops between a high-frequency location and a low-frequency location. PUSCH 701 to PUSCH 704 are in a same low-frequency location while PUSCH 705 to PUSCH 708 are in a same high-frequency position.

However, in process 7100, frequency hopping for the plurality of TRPs does not ensure that transmission to each TRP follows a full hopping procedure. In other words, frequency hopping according to process 7100 is not ideal for each TRP. For example, under the cyclic mapping rule. PUSCH 701.704 for TRP 1 are in the same low-frequency position, which seems that no frequency hopping is performed for transmission to TRP1. Similar situation applies to TRP2, since PUSCH 705-708 for TRP2 are in the same high-frequency position.

In some other embodiments, frequency hopping for PUSCH repetition type A may rely on a counted slot index within the same TRP. Process 7200 shown in FIG. 7 shows another exemplary process of frequency hopping for PUSCH repetition type A.

To make each TRP have a full frequency hopping procedure, for each of the plurality of TRPs, frequency hopping for PUSCH repetition type A may rely on a counted slot index within the same TRP. Specifically, the counted slot index is an alternative slot number counted in a slot sequence within the same TRP and excluding the slots for the PUSCH repetition to the other TRP. For example, the slot numbers of slots 7010, 7020, 7030, and 7040 may be 1, 2, 3.4 within the same radio frame, while the counted slot indices of slots 7010 and 7030 may be 1, 2 within TRP1 and the counted slot indices of slots 7020 and 7040 may be 1, 2 within TRP2. Also, for the repetition in the case of the plurality of TRPs, frequency hopping should be fully completed for each TRP, because each TRP receives PUSCH separately. As can be seen, PUSCHs 709, 711, 713, and 715 hop between a high-frequency location and a low-frequency location and the frequency hopping for TRP1 without being interfered. Similarly, for TRP2, PUSCHs 710, 712, 714, and 716 hop between a high-frequency location and a low-frequency location.

Process 7300 shown in FIG. 7 shows another exemplary process of frequency hopping for PUSCH repetition type A. For sequential mapping, the frequency hopping for TRP1 and TRP2 are considered within the same TRP in process 7300. As can be seen, PUSCHs 709, 711, 713, and 715 hop between a high-frequency location and a low-frequency location and the frequency hopping for TRP1 without being interfered. Similarly, for TRP1, PUSCHs 717, 718, 721, and 722 hop between a high-frequency location and a low-frequency location. For TRP2, PUSCHs 719, 720, 723, and 724 hop between a high-frequency location and a low-frequency location.

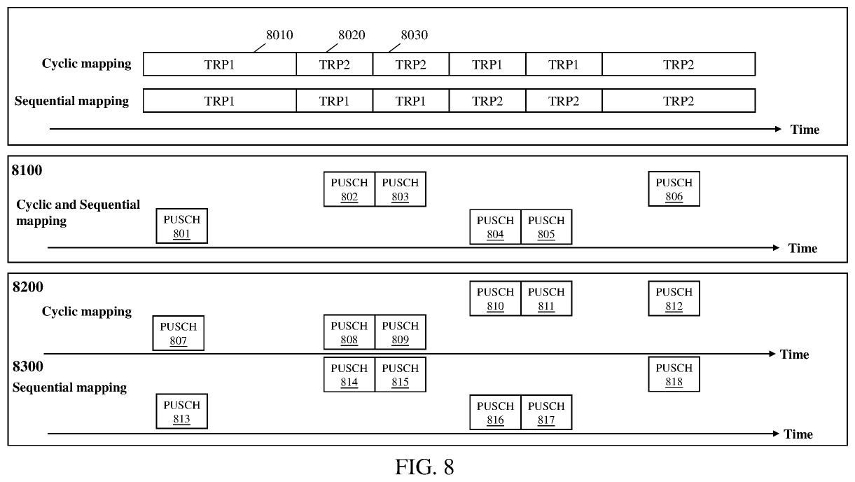

FIG. 8 illustrates another exemplary different frequency bopping results in accordance with some embodiments.

In some embodiments, frequency bopping for PUSCH repetition type B for the plurality of TRPs relies on a nominal repetition index within a radio frame.

The frequency hopping of PUSCH repetition type B is different from that of PUSCH repetition type A in that the value of the different n, which is the index of the nominal repetition across both TRPs.

For PUSCH repetition type B, the back-to-back repetition method is adopted. Therefore, an index indicating a number of the nominal repetition is used for frequency hopping for PUSCH repetition type B, to replace the slot number used in determining frequency hopping for PUSCH repetition type A. Also, the cross-slot boundary or DL symbol merge may occur. When using the index of the nominal repetition, independent indexing should be done for the repetition of each TRP, so that each TRP does full frequency hopping.

Process 8100 is arrived at based on the existing frequency hopping calculation method for inter-slot frequency hopping for PUSCH repetition type B (e.g., equation (2) mentioned above). As shown in process 8100, the PUSCH transmission hops between a high-frequency location and a low-frequency location. PUSCH 801, 804, and 805 are in a same low-frequency location while PUSCH 802, 803, and 806 are in a same high-frequency position.

Similarly, under the cyclic mapping rile, PUSCH for TRP 1 are in the same low-frequency position while PUSCH for TRP2 are in the same high-frequency position, which seems that no frequency hopping is performed for transmission within the same TRP.

In some other embodiments, for each of the plurality of TRPs, frequency hopping for PUSCH repetition type B may rely on a counted nominal repetition index within a same TRP. Process 8200 shown in FIG. 8 shows another exemplary process of frequency hopping for PUSCH repetition type B.

To make each TRP have a full frequency hopping procedure, for each of the plurality of TRPs, frequency hopping for PUSCH repetition type B may rely on a counted nominal repetition index within the same TRP. Specifically, the counted nominal repetition index is an alternative nominal repetition number counted in a slot sequence within the same TRP and excluding the nominal repetitions for other TRP. For example, the nominal repetition numbers of actual repetition 8010, 8020, 8030 be 1, 2, 2 in current spec, while the counted nominal repetition index of actual repetition 8010 may be 1 within TRP1, and the counted nominal repetition indices of slots 8020 and 8030 may be 1, 1 within TRP2. Also, for the repetition in the case of the plurality of TRPs, frequency hopping should be fully completed for each TRP, because each TRP receives PUSCH separately. As can be seen, PUSCHs 807, 810, and 811 hop between a high-frequency location and a low-frequency location and the frequency hopping for TRP1 without being interfered. Similarly, for TRP2, PUSCHs 802, 803, and 806 hop between a high-frequency location and a low-frequency location.

Process 8300 shown in FIG. 3 shows another exemplary process of frequency hopping for PUSCH repetition type A. For sequential mapping, the frequency hopping for TRP1 and TRP2 are considered within the same TRP in process 8300. As can be seen, PUSCHs 709, 711, 713, and 715 hop between a high-frequency location and a low-frequency location and the frequency hopping for TRP1 without being interfered. Similarly, for TRP1, PUSCHs 813, 814, and 315 hop between a high-frequency location and a low-frequency location. For TRP2, PUSCHs 816, 817, and 818 hop between a high-frequency location and a low-frequency location.

Regarding dynamic switching of the sTRP and mTRP PUSCH, the DCI may include a Sounding Resource Signal (SRS) Resource set selection parameter. The SRS resource set selection parameter indicates a mapping between at least one SRS Resource Index (SRI)/Transmit Premier Matrix Indicator (TPMI) field and at least one SRS resource set. Herein, the SRS resource set is a set of resources for defining TRP in a logical way.

The SRS resource set selection parameter may be defined as follows:
Codepoint “00” for the SRS resource set selection parameter: s-TRP mode with the 1^{st} SRS resources set (TRP1), which uses the 1^{st} SRI/TMPI field and the 2°d field is unused.
Codepoint “01” for the SRS resource set selection parameter: s-TRP mode with the 2^{nd} SRS resources set (TRP2), which uses the 1^{st} SRI/TMPI field and the 2°d field is unused.
Codepoint “10” for the SRS resource set selection parameter: m-TRP mode with (TRP1, TRP2 order), the 1^{st} SRI/TPMI field for the 1^{st} SRS resource set and the 2nd SRI/TPMI field for the 2^{nd} SRS resource set. Both 1^{st} and 2^{nd} fields are used.

For the new agreement, two hits are added to DCI to send and specify whether to send s-TRP or m-TRP. The codepoint 00 and 01 is used to indicate the transmission of TRP1 or TRP2 by mapping the 1^{st} SRI/TMPI field to the 1^{st} SRS resource set or the 2^{nd} SRS resource set, and 10 is used to indicate the transmission of two TRPs with a transmission order of TRP1 first and TRP2 second by mapping the 1^{st} SRI/TMPI field to the 1^{st} SRS resource set and the 2^{nd} SRS resource set. A fourth transmission case can be extended to codepoint 11.

Following illustrates implementations associated with codepoint 11.

In some implementations, the SRS resource set selection parameter may indicate a mapping between at least one SRS Resource Index (SRI)/Transmit Precoder Matrix Indicator (TPMI) field and at least one SRS resource set. For example, the 1^{st} SRI/TPMI field may be mapped to the 2^{nd} SRS resource set, and the 2^{nd} SRI/TPMI field may be mapped to the 1^{st} SRS resource set. In some examples, the at least one SRI/TPMI field has a same bit width which is dependent on a maximum size of the at least one SRS resource set. In this way, when changing the mapping manner of the SRI/TPMI fields and the SRS resource set, the bit width of SRI/TPMI field will be compatible for a size of any one of the two SRS resource sets. The 1^{st} SRI/TPMI field may be transmitted first for both codepoints 10 and 11. Thus, the transmission order of the 1^{st} SRS resource set and the 2^{nd} SRS resource set may be exchanged by exchanging the mapping SRI/TPMI field.

In some implementations, the SRS resource set selection parameter may indicate a transmission order of at least one SRS Resource Index (SRI)/Transmit Precoder Matrix Indicator (TPMI) field. In some examples, the bit width of each of the at least one SRI/TPMI field depends on the sizes of a corresponding SRS source set. For example, the bit widths of the 1^{st} and 2^{nd} SRI/TPMI fields may be different. The bit width of the SRI/TPMI field only depends on the size of the 1^{st} SRS resource set, and the bit width of the 2^{nd} SRI/TPMI field only depends on the size of the 2^{nd} SRS resource set. In this way, the mapping SRI/TPMI field for the 1^{st} SRS resource set and the 2^{nd} SRS resource set are the same for both codepoints 10 and 11. The transmission order of the 1^{st} SRS resource set and the 2^{nd} SRS resource set may be exchanged by changing the transmission order of the 1^{st} SRI/TPMI field and the 2^{nd} SRI/TPMI field.

The sizes of different SRS resource sets may be different, so some restrictions are required. Generally, SRS has four usages: “codebook”, “nonCodebook”, “beam management” and “antenna switching”. For UL operations, “codebook” and “antenna switching” are commonly used. Actually. “nonCodebook” does not involve the number of ports, only supports SRS resource of one port.

In some examples, for SRS resource sets configured with the usage of “codebook” or “nonCodebook”, each of the at least one SRS Resource set has the same number of SRS resources. In some other examples, each SRS resource is included in each of the at least one SRS Resource set has a same number of ports. In yet other examples, the maximum numbers of ports for SRS resources in each of the at least one SRS Resource set are the same. That is, even though the SRS resources in each SRS resource set may have different number of ports, for the SRS resource having a maximum number of ports in each SRS resource set, the maximum number are the same.

For SRS resource sets configured with the usage of “codebook”, when mode 2 full power transmission is not configured, all the SRS resources in all SRS resource sets (e.g., both SRS resource sets) have to be configured with the same number of ports. When mode 2 full power transmission is configured, SRS resources in each SRS resource sets can be configured with different number of ports, and the maximum number of ports configured per SRS resource set has to be the same.

In some other implementations, the DCI may include configured grant configuration.

Configured grant support is another method to enhance the PUSCH reliability for the plurality of TRPs. In addition, some restrictions need to be used to determine which parameters need introduction duplication to configure per TRP.

To support the Type I configured grant with PUSCH repetition for the plurality of TRP, one or multiple of the following information IEs can be shared among both TRPs.

In some examples, at least one of the following information elements (IE) in the configured grant configuration is shared between the plurality of TRPs:
frequencyHopping, which includes intraSlot and interSlot.

In particular, PUSCH to both TRP is either both infraSlot frequency hopping, or, both interSlot frequency hopping.
cg-DMRS-Configuration,
mcs-Table, which includes qam256 and qam64LowSE.
mcs-TableTransformPrecoder, which includes qam256 and qam64LowSE.
resourceAllocation, which includes resourceAllocationType0, resourceAllocationType1 and dynamicSwitch. In particular, both TRPs use the same frequency domain resource allocation type.
rbg-Size, which includes config2. In particular, both TRPs use the same RBG size for frequency domain resource allocation.
nrofHARQ-Processes, which can be 1-16. In particular, the same number of HARQ processing for both TRP.
transformPrecoder, which includes enabled and disabled. In particular, the same waveform, i.e., either DFT-s-OFDM or CP-OFDM, is used for both TRP.
timeDomainOffset, which can be 0-5119.
timeDomainAllocation, which can be 0-15. In particular, the same time domain resource allocation is used for both TRP.
frequencyDomainAllocation, In particular, the same frequency domain resource allocation.
mcsAndTBS, which can be 0.31.
antennaPort, which can be 0-31. In particular, the same antenna port configuration for both TRP.
frequencyHoppingOffset, which can be from 1 to maxNrofPhysicalResourceBlocks-1.
dmrs-SeqInitialization, which can be 0.1. This might be independent, so that one dependent DMRS sequence initialization for each TRP.

In some embodiments, the parameter of dmrs-SeqInitialization may be different for different TRPs. If the parameter of dmrs-SeqInitialization are the same for both TRPs, the interference may increase. In addition, selecting 0 for the parameter of dmrs-SeqInitialization means that the first beam selects 0 and the second beam automatically selects 1, so there is no need to add additional bits. Therefore, different initialization can be introduced for different TRPs even if duplication is not introduced.

In the process of configured grants, a DCI/MAC-CE can configure periodic grants, so the overhead is very small. Although flexibility is sacrificed, it is beneficial for periodic transmission.

To support the Type 1 configured grant with PUSCH repetition for the plurality of TRP, at least one of the following information elements (IE) in the configured grant configuration is duplicated for the plurality of TRPs:
powerControlLoopToUse, which includes n0 and n1. It is an independent power control loop for each TRP.
p0-PUSCH-Alpha, which is an Independent P0/α setting for OLPC for each TRP.
srs-ResourceIndicator, which can be 0-15. It is an independent SRI indication for each TRP.
precodingAndNumberOfLayers, which is independent rank and TPMI indication for each TRP.
pathlossReferenceIndex, which can be 0 to maxNrofPUSCH-PathlossReferenceRSs-1. It is an independent pathloss reference signal for each TRP.

It should be noted that two SRS resource sets with the same usage of either “codebook” or “nonCodebook” are configured. The first TRP is associated with the SRS resource set with the smaller SRS resource set ID while the second TRP is associated with the SRS resource set with the larger SRS resource set ID.

To support the Type I configured grant with PUSCH repetition for the plurality of TRP, the configured grant configuration may include a first Redundancy Version (RV) parameter is associated with a first TRP, and a second RV parameter is associated with a second TRP.

In some implementations, the first RV parameter is the same with the second RV parameter.

In some examples, a single repk-RV is configured for the first RV parameter and the second RV parameter. For example, the single repk-RV is mapped to the PUSCH repetition irrespective whether it is for the first TRP or the second TRP. For another example, the same repk-RV is mapped within the PUSCH repetition within the same TRP (e.g., the second TRP). For PUSCH type B repetition, it is either based on nominal repetition or actual repetition.

In some other implementations, the first RV parameter is different from the second RV parameter.

In some examples, Two repK-RV are configured for the first RV parameter and the second parameter, respectively. Specifically, the first repK-RV is associated with the PUSCH associated with the first TRP, and the second repK-RV is associated with the PUSCH associated with the second TRP.

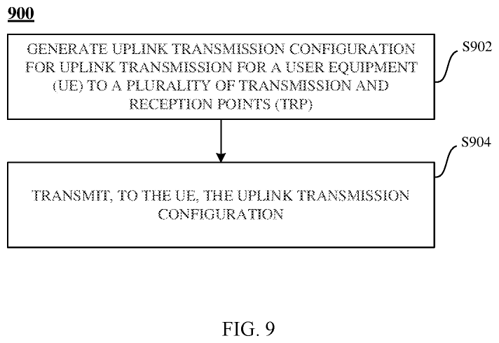

FIG. 9 illustrate an exemplary flowchart of a method for a network device in accordance with some embodiments of the present disclosure.

At step S902, the network device may generate uplink transmission configuration for uplink transmission for a user equipment (UE) to a plurality of transmission and reception points (TRP).

At step 904, the network device may transmit to the UE, Downlink Control Information (DCI) including the uplink transmission configuration.

Since the DCI sent to the UE includes uplink transmission configuration for uplink transmission to a plurality of TRPs, the uplink transmission to each TRP may be configured independently based on uplink transmission configuration for each TRP. Thus, the reliability of uplink transmission to a network including multi-TRPs may be enhanced.

The uplink transmission may be PUCCH transmission or PUSCH transmission, and the details of the uplink transmission configuration are described in connection with FIG. 3-10 above. The UE may use the uplink transmission configuration received from the network device to perform PUCCH transmission or PUSCH transmission accordingly.

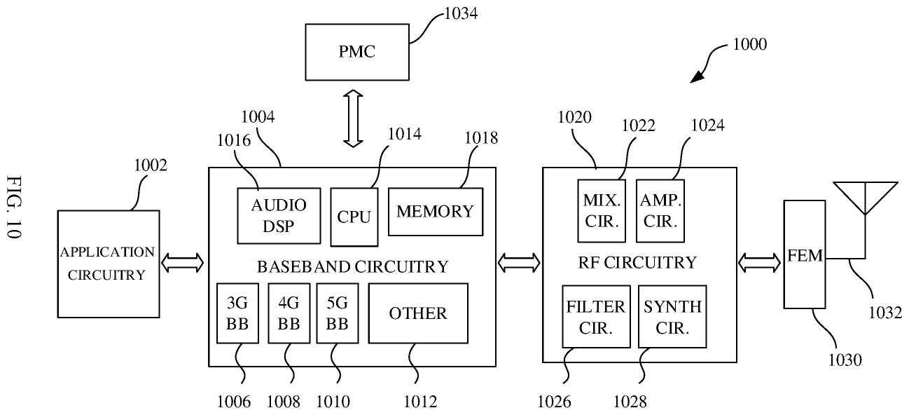

FIG. 10 illustrates example components of a device 1000 in accordance with some embodiments. In some embodiments, the device 1300 may include application circuitry 1002, baseband circuitry 1004, Radio Frequency (RF) circuitry (shown as RF circuitry 1020), front-end module (FEM) circuitry (shown as FEM circuitry 1030), one or more antennas 1032, and power management circuitry (PMC) (shown as PMC 1034 coupled together at least as shown. The components of the illustrated device 1000 may be included in a UE or a RAN node. In some embodiments, the device 1000 may include fewer elements (e.g., a RAN node may not utilize application circuitry 1002, and instead include a processor/controller to process IP data received from an EPC). In some embodiments, the device 1000 may include additional elements such as, for example, memory/storage, display, camera, sensor, or input/output (I/O) interface. In other embodiments, the components described below may be included in more than one device (e.g., said circuitries may be separately included in more than one device for Cloud-RAN C-RAN implementations).

The application circuitry 1002 may include one or more application processors. For example, the application circuitry 1002 may include circuitry such as, but not limited to, one or more single-core or multi-core processors. The processors) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 1000. In some embodiments, processors of application circuitry 1002 may process IP data packets received from an EPC.

The baseband circuitry 1004 may include circuitry such as, but not limited to, one or more single-core or multi-core processors. The baseband circuitry 1004 may include one or more baseband processors or control logic to process baseband signals received from a receive signal path of the RF circuitry 1020 and to generate baseband signals for a transmit signal path of the RF circuitry 1020. The baseband circuitry 1004 may interface with the application circuitry 1002 for generation and processing of the baseband signals and for controlling operations of the RF circuitry 1020. For example, in some embodiments, the baseband circuitry 1004 may include a third generation (3G) baseband processor (3G baseband processor 1006), a fourth generation (4G) baseband processor (46 baseband processor 1008), a fifth generation (5G) baseband processor (5G baseband processor 1010), or other baseband processor(s) 1012 for other existing generations, generations in development or to be developed in the future (e.g., second generation (2G), sixth generation (6G), etc.). The baseband circuitry 1004 (e.g., one or more of baseband processors) may handle various radio control functions that enable communication with one or more radio networks via the RF circuitry 1020. In other embodiments, some or all of the functionality of the illustrated baseband processors may be included in modules stored in the memory 1018 and executed via a Central Processing ETnit (CPET 1014). The radio control functions may include, but are not limited to, signal modulation/demodulation, encoding/decoding, radio frequency shifting, etc. In some embodiments, modulation/demodulation circuitry of the baseband circuitry 1004 may include Fast-Fourier Transform (FFT), precoding, or constellation mapping/demapping functionality. In some embodiments, encoding/decoding circuitry of the baseband circuitry 1004 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 1004 may include a digital signal processor (DSP), such as one or more audio DSP(s) 1016. The one or more audio DSP(s) 1016 may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 1004 and the application circuitry 1002 may be implemented together such as, for example, on a system on a chip (SOC).

In some embodiments, the baseband circuitry 1004 may provide for communication compatible with one or more radio technologies. For example, in some embodiments, the baseband circuitry 1004 may support communication with an evolved universal terrestrial radio access network (EUTRAN) or other wireless metropolitan area networks (WMAN), a wireless local area network (WLAN), or a wireless personal area network (WPAN). Embodiments in which the baseband circuitry 1004 is configured to support radio communications of more than one wireless protocol may be referred to as multi-mode baseband circuitry.

The RF circuitry 1020 may enable communication with wireless networks using modulated electromagnetic radiation through a non-solid medium. In various embodiments, the RF circuitry 1020 may include switches, filters, amplifiers, etc. to facilitate the communication with the wireless network. The RF circuitry 1020 may include a receive signal path which may include circuitry to down-convert RF signals received from the FEM circuitry 1030 and provide baseband signals to the baseband circuitry 1004. The RF circuitry 1020 may also include a transmit signal path which may include circuitry to up-convert baseband signals provided by the baseband circuitry 1004 and provide RF output signals to the FEM circuitry 1030 for transmission.

In some embodiments, the receive signal path of the RF circuitry 1020 may include mixer circuitry 1022, amplifier circuitry 1024 and filter circuitry 1026. In some embodiments, the transmit signal path of the RF circuitry 1020 may include filter circuitry 1026 and mixer circuitry 1022. The RF circuitry 1020 may also include synthesizer circuitry 1028 for synthesizing a frequency for use by the mixer circuitry 1022 of the receive signal path and the transmit signal path. In some embodiments, the mixer circuitry 1022 of the receive signal path may be configured to down-convert RF signals received from the FEM circuitry 1030 based on the synthesized frequency provided by synthesizer circuitry 1028. The amplifier circuitry 1024 may be configured to amplify the down-converted signals and the filter circuitry 1026 may be a low-pass filter (LPF) or band-pass filter (BPF) configured to remove unwanted signals from the down-converted signals to generate output baseband signals. Output baseband signals may be provided to the baseband circuitry 1004 for further processing. In some embodiments, the output baseband signals may be zero-frequency baseband signals, although this is not a requirement. In some embodiments, the mixer circuitry 1022 of the receive signal path may comprise passive mixers, although the scope of the embodiments is not limited in this respect.

In some embodiments, the mixer circuitry 1022 of the transmit signal path may be configured to up-convert input baseband signals based on the synthesized frequency provided by the synthesizer circuitry 1028 to generate RF output signals for the FEM circuitry 1030. The baseband signals may be provided by the baseband circuitry 1004 and may be filtered by the filter circuitry 1026.

In some embodiments, the mixer circuitry 1022 of the receive signal path and the mixer circuitry 1022 of the transmit signal path may include two or more mixers and may be arranged for quadrature downconversion and upconversion, respectively. In some embodiments, the mixer circuitry 1022 of the receive signal path and the mixer circuitry 1022 of the transmit signal path may include two or more mixers and may be arranged for image rejection (e.g., Hartley image rejection). In some embodiments, the mixer circuitry 1022 of the receive signal path and the mixer circuitry 1022 may be arranged for direct downconversion and direct upconversion, respectively. In some embodiments, the mixer circuitry 1022 of the receive signal path and the mixer circuitry 1022 of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 1020 may include analog-to-digital converter (ADC) and digital-to-analog converter (DAC) circuitry and the baseband circuitry 1004 may include a digital baseband interface to communicate with the RF circuitry 1020.

In some dual-mode embodiments, a separate radio IC circuitry may be provided for processing signals for each spectrum, although the scope of the embodiments is not limited in this respect.

In some embodiments, the synthesizer circuitry 1028 may be a fractional —N synthesizer or a fractional N/N+1 synthesizer, although the scope of the embodiments is not limited in this respect as other types of frequency synthesizers may be suitable. For example, synthesizer circuitry 1028 may be a delta-sigma synthesizer, a frequency multiplier, or a synthesizer comprising a phase-locked loop with a frequency divider.

The synthesizer circuitry 1028 may be configured to synthesize an output frequency for use by the mixer circuitry 1022 of the RF circuitry 1020 based on a frequency input and a divider control input. In some embodiments, the synthesizer circuitry 1028 may be a fractional N/N+1 synthesizer.

In some embodiments, frequency input may be provided by a voltage controlled oscillator (VCO), although that is not a requirement. Divider control input may be provided by either the baseband circuitry 1004 or the application circuitry 1002 (such as an applications processor) depending on the desired output frequency. In some embodiments, a divider control input (e.g., N) may be determined from a look-up table based on a channel indicated by the application circuitry 1002.

Synthesizer circuitry 1028 of the RF circuitry 1020 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, the synthesizer circuitry 1028 may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 1020 may include an IQ/polar converter.

The FEM circuitry 1030 may include a receive signal path which may include circuitry configured to operate on RF signals received from one or more antennas 1032, amplify the received signals and provide the amplified versions of the received signals to the RF circuitry 1020 for further processing. The FEM circuitry 1030 may also include a transmit signal path which may include circuitry configured to amplify signals for transmission provided by the RF circuitry 1020 for transmission by one or more of the one or more antennas 1032. In various embodiments, the amplification through the transmit or receive signal paths may be done solely in the RF circuitry 1020, solely in the FEM circuitry 1030, or in both the RF circuitry 1020 and the FEM circuitry 1030.

In some embodiments, the FEM circuitry 1030 may include a TX/RX switch to switch between transmit mode and receive mode operation. The FEM circuitry 1030 may include a receive signal path and a transmit signal path. The receive signal path of the FEM circuitry 1030 may include an LNA to amplify received RF signals and provide the amplified received RF signals as an output (e.g., to the RF circuitry 1020). The transmit signal path of the FEM circuitry 1030 may include a power amplifier (PA) to amplify input RF signals (e.g., provided by the RF circuitry 1020), and one or more filters to generate RF signals for subsequent transmission (e.g., by one or more of the one or more antennas 1032).

In some embodiments, the PMC 1034 may manage power provided to the baseband circuitry 1004. In particular, the PMC 1034 may control power-source selection, voltage scaling, battery charging, or DC-to-DC conversion. The PMC 1034 may often be included when the device 1000 is capable of being powered by a battery, for example, when the device 1000 is included in a EGE. The PMC 1034 may increase the power conversion efficiency while providing desirable implementation size and heat dissipation characteristics.

FIG. 10 shows the PMC 1034 coupled only with the baseband circuitry 1004. However, in other embodiments, the PMC 1034 may be additionally or alternatively coupled with, and perform similar power management operations for, other components such as, but not limited to, the application circuitry 1002, the RF circuitry 1020, or the FEM circuitry 1030.

In some embodiments, the PMC 1034 may control, or otherwise be part of, various power saving mechanisms of the device 1000. For example, if the device 1000 is in an RRC Connected state, where it is still connected to the RAN node as it expects to receive traffic shortly, then it may enter a state known as Discontinuous Reception Mode (DRX) after a period of inactivity. During this state, the device 1000 may power down for brief intervals of time and thus save power.

If there is no data traffic activity for an extended period of time, then the device 1000 may transition off to an RRC Idle state, where it disconnects from the network and does not perform operations such as channel quality feedback, handover, etc. The device 1000 goes into a very low power state and it performs paging where again it periodically wakes up to listen to the network and then powers down again. The device 1000 may not receive data in this state, and in order to receive data, it transitions back to an RRC Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 1002 and processors of the baseband circuitry 1004 may be used to execute elements of one or more instances of a protocol stack. For example, processors of the baseband circuitry 1004, alone or in combination, may be used to execute Layer 3, Layer 2, or Layer 1 functionality, while processors of the application circuitry 1002 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

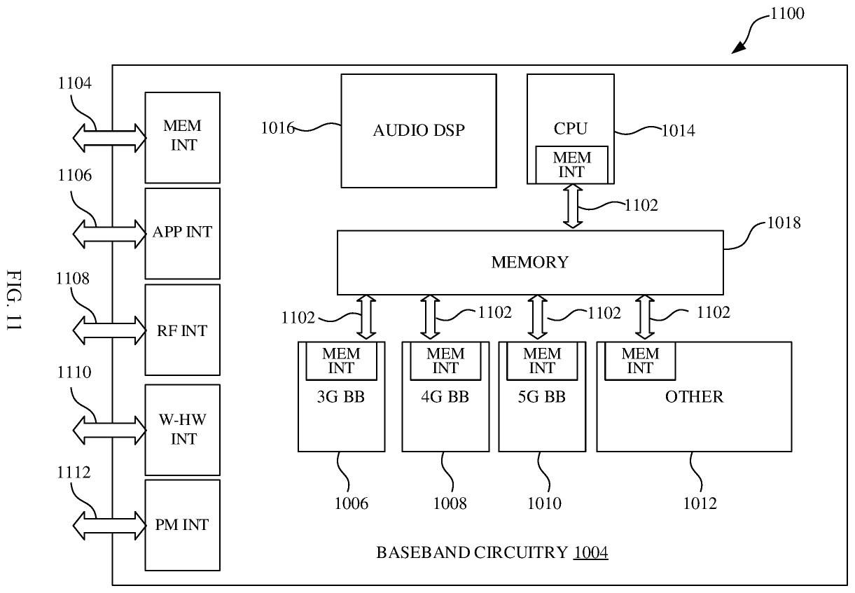

FIG. 11 illustrates example interfaces 1100 of baseband circuitry in accordance with some embodiments. As discussed above, the baseband circuitry 1004 of FIG. 10 may comprise 3G baseband processor 1006. 4G baseband processor 1008, 5G baseband processor 1010, other baseband processor(s) 1012, CPU 1014, and a memory 1018 utilized by said processors. As illustrated, each of the processors may include a respective memory interface 1102 to send/receive data to/from the memory 1018.

The baseband circuitry 1004 may further include one or more interfaces to communicatively couple to other circuitries/devices, such as a memory interface 1104 (e.g., an interface to send/receive data to/front memory external to the baseband circuitry 1004), an application circuitry interface 1106 (e.g., an interface to send/receive data to/from the application circuitry 1002 of FIG. 10), an RF circuitry interface 1108 (e.g., an interface to send/receive data to/from RF circuitry 1320 of FIG. 10), a wireless hardware connectivity interface 1110 (e.g., an interface to send/receive data to/from Near Field Communication (NFC) components, Bluetooth® components (e.g., Bluetooth® Low Energy), Wi-Fi® component, and other communication components), and a power management interface 1112 (e.g., an interface to send/receive power or control signals to/from the PMC 1034.

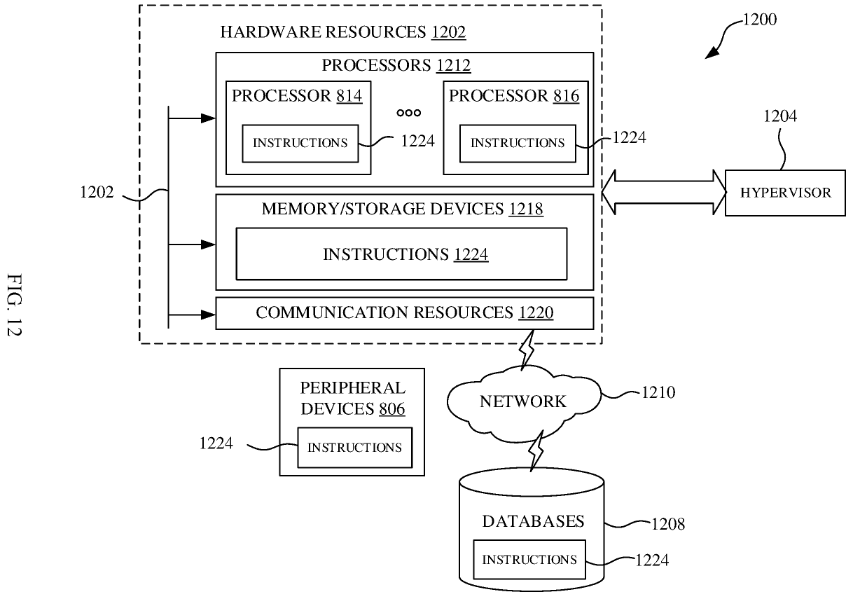

FIG. 12 is a block diagram illustrating components 1200, according to some example embodiments, able to read instructions from a machine-readable or computer-readable medium (e.g., a non-transitory machine-readable storage medium) and perform any one or more of the methodologies discussed herein. Specifically, FIG. 12 shows a diagrammatic representation of hardware resources 1202 including one or more processors 1212 (or processor cores), one or more memory/storage devices 1218, and one or more communication resources 1220, each of which may be communicatively coupled via a bus 1222. For embodiments where node virtualization (e.g., NFV) is utilized, a hypervisor 1204 may be executed to provide an execution environment for one or more network slices/sub-slices to utilize the hardware resources 1202.

The processors 1212 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1214 and a processor 1216.

The memory/storage devices 1218 may include main memory, disk storage, or any suitable combination thereof. The memory/storage devices 1218 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 1220 may include interconnection or network interface components or other suitable devices to communicate with one or mom peripheral devices 1206 or one or more databases 1208 via a network 1212. For example, the communication resources 1220 may include wired communication components (e.g., for coupling via a Universal Serial Bus (USB)), cellular communication components, NFC components, Bluetooth® components (e.g., Bluetooth® Low Energy), Wi-Fick components, and other communication components.

Instructions 1224 may comprise software, a program, an application, an applet, an app, or other executable code for causing at least any of the processors 1212 to perform any one or more of the methodologies discussed herein. The instructions 1224 may reside, completely or partially, within at least one of the processors 1212 (e.g., within the processor's cache memory), the memory/storage devices 1218, or any suitable combination thereof. Furthermore, any portion of the instructions 1224 may be transferred to the hardware resources 1202 from any combination of the peripheral devices 1206 or the databases 1208. Accordingly, the memory of the processors 1212, the memory/storage devices 1218, the peripheral devices 1206, and the databases 1208 are examples of computer-readable and machine-readable media.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

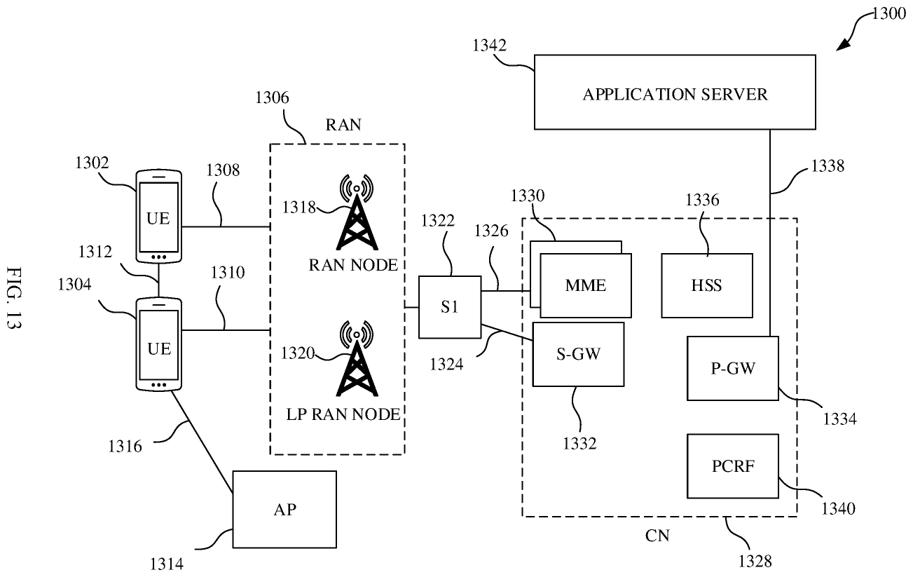

FIG. 13 illustrates an architecture of a system 1300 of a network in accordance with some embodiments. The system 1300 includes one or more user equipment (UE), shown in this example as a UE 1302 and a UE 1304. The UE 1302 and the UE 1304 are illustrated as smartphones (e.g., handheld touchscreen mobile computing devices connectable to one or more cellular networks), but may also comprise any mobile or non-mobile computing device, such as Personal Data Assistants (PDAs), pagers, laptop computers, desktop computers, wireless handsets, or any computing device including a wireless communications interface.

In some embodiments, any of the UE 1302 and the UE 1304 can comprise an Internet of Things (IoT) UE, which can comprise a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UE 1302 and the UE 1304 may be configured to connect, e.g., communicatively couple, with a radio access network (RAN), shown as RAN 1306. The RAN 1306 may be, for example, an Evolved ETniversal Mobile Telecommunications System (ETMTS) Terrestrial Radio Access Network (E-UTRAN), a NextGen RAN (NG RAN), or some other type of RAN. The UE 1302 and the UE 1304 utilize connection 1308 and connection 1310, respectively, each of which comprises a physical communications interface or layer (discussed in further detail below); in this example, the connection 1308 and the connection 1310 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LIE) protocol, a fifth generation (5G) protocol, a New Radio (NR) protocol, and the like.

In this embodiment, the UE 1302 and the UE 1304 may further directly exchange communication data via a ProSe interface 1312. The ProSe interface 1312 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 1304 is shown to be configured to access an access point (AP), shown as AP 1314, via connection 1316. The connection 1316 can comprise a local wireless connection, such as a connection consistent with any IEEE 802.11 protocol, wherein the AP 1314 would comprise a wireless fidelity (WiFi®) router. In this example, the AP 1314 may be connected to the Internet without connecting to the core network of the wireless system (described in further detail below).

The RAN 1306 can include one or more access nodes that enable the connection 1308 and the connection 1310. These access nodes (ANs) can be referred to as base stations (BSs), NodeBs, evolved NodeBs (eNBs), next Generation NodeBs (RNB), RAN nodes, and so forth, and can comprise ground stations (e.g., terrestrial access points) or satellite stations providing coverage within a geographic area (e.g., a cell). The RAN 1306 may include one or more RAN nodes for providing macrocells, e.g., macro RAN node 1318, and one or more RAN nodes for providing femtocells or picocells (e.g., cells having smaller coverage areas, smaller user capacity, or higher bandwidth compared to macrocells), e.g., a low power (LP) RAN node such as LP RAN node 1320.

Any of the macro RAN node 1318 and the LP RAN node 1320 can terminate the air interface protocol and can be the first point of contact for the UE 1302 and the UE 1304. In some embodiments, any of the macro RAN node 1318 and the LP RAN node 1320 can fulfill various logical functions for the RAN 1306 including, but not limited to, radio network controller (RNC) functions such as radio bearer management, uplink and downlink dynamic radio resource management and data packet scheduling, and mobility management.

In accordance with some embodiments, the EGE 1302 and the EGE 1304 can be configured to communicate using Orthogonal Frequency-Division Multiplexing (OFDM) communication signals with each other or with any of the macro RAN node 1318 and the LP RAN node 1320 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can comprise a plurality of orthogonal sub carriers.

In some embodiments, a downlink resource grid can be used for downlink transmissions from any of the macro RAN node 1318 and the LP RAN node 1320 to the UE 1302 and the UE 1304, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements: in the frequency domain, this may represent the smallest quantity of resources that currently can be allocated. There are several different physical downlink channels that are conveyed using such resource blocks.

The physical downlink shared channel (PDSCH) may carry user data and higher-layer signaling to the UE 1302 and the UE 1304. The physical downlink control channel (PDCCH) may carry information about the transport format and resource allocations related to the PDSCH channel, among other things. It may also inform the UE 1302 and the UE 1304 about the transport format, resource allocation, and H-ARQ (Hybrid Automatic Repeat Request) information related to the uplink shared channel. Typically, downlink scheduling (assigning control and shared channel resource blocks to the UE 1304 within a cell) may be performed at any of the macro RAN node 1318 and the LP RAN node 1320 based on channel quality information fed hack from any of the UE 1302 and UE 1304. The downlink resource assignment information may be sent on the PDCCH used for (e.g., assigned to) each of the UE 1302 and the UE 1304.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs). Similar to above, each ECCE may correspond to nine sets of four physical resource elements known as enhanced resource element groups (EREGs). An ECCE may have other numbers of EREGs in some situations.

The RAN 1306 is communicatively coupled to a core network (CN), shown as CN 1328—via an S1 interface 1322. In embodiments, the CN 1328 may be an evolved packet core (EPC) network, a NextGen Packet Core (NPC) network, or some other type of CN. In this embodiment the S1 interface 1322 is split into two parts: the S1-U interface 1324, which carries traffic data between the macro RAN node 1318 and the LP RAN node 1320 and a serving gateway (S-GW), shown as S-GW 1332, and an S1-mobility management entity (MME) interface, shown as S1-MME interface 1326, which is a signaling interface between the macro RAN node 1318 and LP RAN node 1320 and the MME(s) 1330.

In this embodiment, the CN 1328 comprises the MME(s) 1330, the S-GW 1332, a Packet Data Network (PDN) Gateway (P-GW) (shown as P-GW 1334), and a home subscriber server (HSS) (shown as HSS 1336). The MME(s) 1330 may be similar in function to the control plane of legacy Serving General Packet Radio Service (GPRS) Support Nodes (SGSN). The MME(s) 1330 may manage mobility aspects in access such as gateway selection and tracking area list management. The HSS 1336 may comprise a database for network users, including subscription-related information to support the network entities' handling of communication sessions. The CN 1328 may comprise one or several HSS 1336, depending on the number of mobile subscribers, on the capacity of the equipment, on the organization of the network, etc. For example, the HSS 1336 can provide support for muting/roaming, authentication, authorization, naming/addressing resolution, location dependencies, etc.

The S-GW 1332 may terminate the S1 interface 322 towards the RAN 1306, and routes data packets between the RAN 1306 and the CN 1328. In addition, the S-GW 1332 may be a local mobility anchor point for inter-RAN node handovers and also may provide an anchor for inter-3 GPP mobility. Other responsibilities may include lawful intercept, charging, and some policy enforcement.

The P-GW 1334 may terminate an SGi interface toward a PDN. The P-GW 1334 may route data packets between the CN 1328 (e.g., an EPC network) and external networks such as a network including the application server 1342 (alternatively referred to as application function (AF)) via an Internet Protocol (IP) interface (shown as IP communications interface 1338). Generally, an application server 1342 may be an element offering applications that use IP bearer resources with the core network (e.g., ETMTS Packet Services (PS) domain, LTE PS data services, etc.). In this embodiment, the P-GW 1334 is shown to be communicatively coupled to an application server 1342 via an IP communications interface 1338. The application server 1342 can also be configured to support one or more communication services (e.g., Voice-over-Internet Protocol (VoIP) sessions, PTT sessions, group communication sessions, social networking services, etc.) for the UE 1302 and the UE 1304 via the CN 1328.

The P-GW 1334 may further be a node for policy enforcement and charging data collection. A Policy and Charging Enforcement Function (PCRF) (shown as PCRF 1340) is the policy and charging control element of the CN 1328. In a non-roaming scenario, there may be a single PCRF in the Home Public Land Mobile Network (HPLMN) associated with a ETE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 1340 may be communicatively coupled to the application server 1342 via the P-GW 1334. The application server 1342 may signal the PCRF 1340 to indicate a new service flow and select the appropriate Quality of Service (QoS) and charging parameters. The PCRF 1340 may provision this rule into a Policy and Charging Enforcement Function (PCEF) (not shown) with the appropriate traffic flow template (TFT) and QoS class of identifier (QCI), which commences the QoS and charging as specified by the application server 1342.

### ADDITIONAL EXAMPLES

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

The following examples pertain to further embodiments.

Example 1 is a method for a user equipment (UE), comprising: obtaining, from a network device, uplink transmission configuration for uplink transmission to a plurality of transmission and reception points (TRP), the uplink transmission configuration being included in Radio Resource Control (RRC) message or Media Access Control (MAC) Control Element (MAC-CE) or Downlink Control Information (DCI); performing uplink transmission to the plurality of TRPs based on the uplink transmission configuration.

Example 2 is the method of example 1, wherein the uplink transmission is Physical Uplink Control Channel (PUCCH) transmission.

Example 3 is the method of example 2, wherein the uplink transmission configuration includes a closed loop power control (CLPC) parameter for the plurality of TRPs.

Example 4 is the method of example 3, wherein the CLPC parameter includes different closed loop indices for different TRPs.

Example 5 is the method of example 3, wherein the CLPC parameter includes a same closed loop index for different TRPs.

Example 6 is the method of example 3, wherein the CLPC parameter include Transmission Power Control (TPC) parameters for the plurality of TRPs.

Example 7 is the method of example 6, wherein the DCI includes a single TPC field, and the TPC parameters are defined in the single TPC field.

Example 8 is the method of example 7, wherein the single TPC field is configured in case that a same closed loop index is defined for different TRPs.

Example 9 is the method of example 7, wherein a first set of bits in the TPC field is configured for a first TPC parameter for a first TRP of the plurality of TRPs, and a second set of bits in the TPC field is configured for a second TPC parameter for a second TRP of the plurality of TRPs.

Example 10 is the method of example 9, wherein the TPC field includes 4 bits.

Example 11 is the method of example 6, wherein in case that single TRP sTRP operation through one TRP of the plurality of TRPs is scheduled, the TPC parameter is used for updating corresponding CLPC for the scheduled TRP, and in case that multiple TRP (mTRP) operation through the plurality of TRPs is scheduled, the TPC parameter is used for updating CLPC for the plurality of TRPs.

Example 12 is the method of example 6, wherein the DCI includes a plurality of TPC fields.

Example 13 is the method of example 12, wherein the DCI includes a plurality of TPC fields in case that different closed loop indices are configured for different TRPs.

Example 14 is the method of example 12, wherein in case that a same closed loop index is configured for different TRPs, the UE applies one TPC field of the plurality of TPC fields or all of the plurality of TPC fields to CLPC with the same closed loop index.

Example 15 is the method of example 12, wherein in case that different closed loop indices are configured for different TRPs, the UE applies a first TPC field of the plurality of TPC fields to CLPC corresponding to a first closed loop index, and a second TPC field of the plurality of TPC fields to CLPC corresponding to a second closed loop index.

Example 16 is the method of example 12, wherein the DCI further includes a toggling indication indicating toggling between a single TRP (sTRP) operation and a multiple TRP (mTRP) operation, and the UE applies one TPC field of the plurality of TPC fields or all of the plurality of TPC fields based on the toggling indication.

Example 17 is the method of example 2, wherein the uplink transmission configuration includes at least one set of spatial relation information, and each PUCCH resource for PUCCH transmission is associated with the at least one set of spatial relation information.

Example 18 is the method of example 17, wherein the DCI or MAC-CE or RRC includes associations indicating that each PUCCH resource is associated with a plurality of sets of spatial relation information, and each set of spatial relation information is used for one TRP of the plurality of the TRPs.

Example 19 is the method of example 17, wherein the DCI or MAC-CE or RRC includes associations indicating that each PUCCH resource is associated with one set of spatial relation information, and the set of spatial relation information includes a plurality of subsets of spatial relation parameters, each subset of spatial relation parameters is used for one TRP of the plurality of the TRPs.

Example 20 is the method of example 17, wherein the set of spatial relation information includes beam management parameters and power control parameters in Frequency Range 2 (FR2).

Example 21 is the method of example 17, wherein the set of spatial relation information includes power control parameters without beam management parameters in Frequency Range 1 (FR).

Example 22 is the method of example 2, wherein the uplink transmission configuration includes repetition configuration, and the repetition configuration indicates that a PUCCH repetition is taken away from a configured number of PUCCH repetitions when the PUCCH repetition is invalid.

Example 23 is the method of example 2, wherein the uplink transmission configuration includes repetition configuration, and the repetition configuration indicates that a PUCCH repetition is skipped when the PUCCH repetition is invalid and continues the PUCCH repetition until configured number of PUCCH repetitions are done.

Example 24 is the method of example 1, wherein the uplink transmission is Physical Uplink Shared Channel (PUSCH) transmission.

Example 25 is the method of example 24, wherein frequency hopping for PUSCH repetition type A for the plurality of TRPs relies on a slot number within a radio frame.

Example 26 is the method of example 24, wherein for each of the plurality of TRPs, frequency hopping for PUSCH repetition type A relies on a counted slot index within a same TRP.

Example 27 is the method of example 24, wherein frequency hopping for PUSCH repetition type B for the plurality of TRPs relies on a nominal repetition index within a radio frame.

Example 28 is the method of example 24, wherein for each of the plurality of TRPs, frequency hopping for PUSCH repetition type B relies on a counted nominal repetition index within a same TRP.

Example 29 is the method of example 24, wherein the DCI includes a Sounding Resource Signal (SRS) resource set selection parameter, wherein the SRS resource set selection parameter indicates a mapping between at least one SRS Resource Index (SRI)/Transmit Precoder Matrix Indicator (TPMI) field and at least one SRS resource set.

Example 30 is the method of example 29, wherein the at least one SRI/TPMI field has a same bit width which is dependent on a maximum size of the at least one SRS resource set.

Example 31 is the method of example 24, wherein the DCI includes a Sounding Resource Signal (SRS) Resource set selection parameter, wherein the SRS resource set selection parameter indicates a transmission order of at least one SRS Resource Index (SRI)/Transmit Precoder Matrix Indicator (TPMI) field.

Example 32 is the method of example 31, wherein a bit width of each of the at least ore SRI/TPMI field depends on sizes of a corresponding SRS source set.

Example 33 is the method of any one of examples 27-32, wherein each of the at least one SRS Resource set has a same number of SRS resources.

Example 34 is the method of any one of examples 27-33, wherein each SRS resource included in each of the at least one SRS Resource set has a same number of ports.

Example 35 is the method of any one of examples 27-33, wherein maximum numbers of ports for SRS resources in each of the at least one SRS Resource set are the same.

Example 36 is the method of example 1, wherein the DCI includes configured grant configuration.

Example 37 is the method of example 36, wherein at least one of the following information elements (IE) in the configured grant configuration is shared between the plurality of TRPs:
frequencyHopping.
cg-DMRS-Configuration,
mcs-Table,
mcs-TableTransformPrecoder
resourceAllocation,
rbg-Size,
nrofHARQ-Processes.
transformPrecoder,
timeDomainOffset,
timeDomainAllocation,
frequencyDomainAllocation
mcsAndTBS,
antennaPort,
frequencyHoppingOffset,
dmrs-SeqInitialization.

Example 38 is the method of example 36 or 37, wherein at least one of the following information elements (IE) in the configured grant configuration is duplicated for the plurality of TRPs:
powerControlLoopToUse,
p0-PUSCH-Alpha,
srs-ResourceIndicator,
precodingAndNumberOfLayers,
pathlossReferenceIndex.

Example 39, is the method of example 36, wherein the configured grant configuration includes a first Redundancy Version (RV) parameter is associated with a first TRP, and a second RV parameter is associated with a second TRP.

Example 40 is the method of example 39, the first RV parameter is the same with the second RV parameter.

Example 41 is the method of example 39, the first RV parameter is different from the second RV parameter.

Example 42 is a method for a network device, comprising generating uplink transmission configuration for uplink transmission for a user equipment (UE) to a plurality of transmission and reception points (TRP); transmitting, to the UE, Downlink Control Information (DCI) including the uplink transmission configuration.

Example 43 is an apparatus for a user equipment (UE), the apparatus comprising: one or more processors configured to perform steps of the method according to any of examples 1-41.

Example 44 is an apparatus of a network device, the apparatus comprising: one or more processors configured to perform steps of the method according to example 42.

Example 45 is a computer readable medium having computer programs stored thereon which, when executed by one or more processors, cause an apparatus to perform steps of the method according to any of examples 1.42.

Example 46 is an apparatus for a communication device, comprising means for performing steps of the method according to any of examples 1-42.

Example 47 is a computer program product comprising computer programs which, when executed by one or more processors, cause an apparatus to perform steps of the method according to any of examples 1-42.

Any of the above described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

It should be recognized that the systems described herein include descriptions of specific embodiments. These embodiments can be combined into single systems, partially combined into other systems, split into multiple systems or divided or combined in other ways. In addition, it is contemplated that parameters/attributes/aspects/etc. of one embodiment can be used in another embodiment. The parameters/attributes/aspects/etc. am merely described in one or more embodiments for clarity, and it is recognized that the parameters/attributes/aspects/etc. can be combined with or substituted for parameters/attributes/etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there am many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1.-48. (canceled)

49. A method for a user equipment (UE), the method comprising:
obtaining, from a network device, uplink transmission configuration for a Physical Uplink Shared Channel (PUSCH) transmission to a plurality of transmission and reception points (TRPs), the uplink transmission configuration including a Sounding Resource Signal (SRS) resource set selection parameter transmitted in Downlink Control Information (DCI); and
transmitting the PUSCH transmission to the plurality of TRPs based on the uplink transmission configuration.

50. The method of claim 49, wherein the SRS resource set selection parameter is to indicate a mapping between at least one SRS resource index (SRI)/Transmit Precoder Matrix Indicator (TPMI) field and at least one SRS resource set.

51. The method of claim 50, wherein the at least one SRI/TPMI field includes a first SRI/TPMI field and a second SRI/TPMI field, the at least one SRS resource set includes a first SRS resource set and a second SRS resource set, and the mapping is to map the first SRI/TPMI field to the first SRS resource set and the second SRI/TPMI field to the second SRS resource set.

52. The method of claim 51, wherein the second SRS resource set is associated with a first transmission interval and the first SRS resource set is associated with a second transmission interval, which occurs after the first transmission interval.

53. The method of claim 51, wherein both the first SRS resource set and the second SRS resource set are configured with: a codebook usage or a non-codebook usage; and a same number of SRS resources.

54. The method of claim 50, wherein the SRS resource set selection parameter comprises a codepoint of “11”.

55. The method of claim 49, wherein the DCI comprises DCI format 0_2.

56. A base station comprising:
processing circuitry to generate a radio resource control (RRC) message with a configured grant configuration that is to configure an uplink transmission for a plurality of transmission and reception points (TRPs), the configured grant configuration to include a first field to provide a first configuration of a type for transmission to a first TRP of the plurality of TRPs and a second field to provide a second configuration of the type for transmission to a second TRP of the plurality of TRPs; and
radio-frequency (RF) circuitry coupled with the processing circuitry, the RF circuitry to transmit the RRC message to a user equipment.

57. The base station of claim 56, wherein the type is a power-control-loop-to-use type, the first configuration is to indicate a first power control loop to use for the first TRP, and the second configuration is to indicate a second power control loop to use for the second TRP.

58. The base station of claim 56, wherein the type is a P0-PUSCH-Alpha type, the first configuration is to indicate a first P0 alpha setting to use for open loop power control for the first TRP, and the second configuration is to indicate a second P0 alpha setting to use for open loop power control for the second TRP.

59. The base station of claim 56, wherein the type is a sounding reference signal resource indicator (SRI) type, the first configuration is to indicate a first SRI indication for the first TRP, and the second configuration is to indicate a second SRI indication for the second TRP.

60. The base station of claim 56, wherein the type is a precoding-and-number-of-layers type, the first configuration is to indicate a first precoding and number of layers for the first TRP, and the second configuration is to indicate a first precoding and number of layers for the second TRP.

61. The base station of claim 56, wherein the type is a pathloss-reference-index type, the first configuration is to indicate a first pathloss reference signal for the first TRP, and the second configuration is to indicate a second pathloss reference signal for the second TRP.

62. The base station of claim 56, wherein the configured grant configuration is a Type I configured grant.

63. The base station of claim 56, wherein the configured grant configuration is for physical uplink shared channel (PUSCH) repetition.

64. One or more non-transitory, computer-readable media having instructions that, when executed, cause a user equipment (UE) to:
obtain, from a network device, uplink transmission configuration to provide a configured grant with Physical Uplink Shared Channel (PUSCH) repetition for a plurality of transmission and reception points (TRPs), the uplink transmission configuration to include a redundancy version (RV) parameter; and
transmit a PUSCH transmission to the plurality of TRPs based on the RV parameter.

65. The one or more non-transitory, computer-readable media of claim 64, wherein the configured grant is a Type I configured grant.

66. The one or more non-transitory, computer-readable media of claim 64, wherein the uplink transmission configuration is to include a Sounding Resource Signal (SRS) resource set selection parameter.

67. The one or more non-transitory, computer-readable media of claim 64, wherein the uplink transmission configuration is to include a first field to provide a first configuration of a type for transmission to a first TRP of the plurality of TRPs and a second field to provide a second configuration of the type for transmission to a second TRP of the plurality of TRPs.

68. The one or more non-transitory, computer-readable media of claim 64, wherein the RV parameter is a repK-RV and, to transmit the PUSCH transmission, the circuitry is to transmit the PUSCH transmission to a first TRP of the plurality of TRPs using the repK-RV and transmit the PUSCH transmission to a second TRP of the plurality of TRPs using the repK-RV.
